(19) United States
(12) Patent Application Publication
(10) Pub. No.: US 2012/0090165 A1
(43) Pub. Date: Apr. 19, 2012

(54) APPARATUS AND METHOD FOR MANUFACTURING ELECTROMAGNETIC SWITCH

(75) Inventor: Young Myoung YEON, Chungcheongbuk-Do (KR)

(73) Assignee: LSIS CO., LTD.

(21) Appl. No.: 13/273,132

(22) Filed: Oct. 13, 2011

(30) Foreign Application Priority Data
Oct. 15, 2010 (KR) 10-2010-0100774

(51) Int. Cl. H01H 11/00

(52) U.S. Cl. 29/622

(57) ABSTRACT

Disclosed is an electromagnetic switch capable of sealing a hermetic space after injecting extinguishing gas into the hermetic space. An apparatus for manufacturing an electromagnetic switch includes a chamber having an inner space hermetically sealed from outside, an extinguishing gas injector configured to inject extinguishing gas into the chamber, a supporter disposed in the chamber, and configured to support a temporary assembly having a vent hole at one side thereof, and a sealing means configured to seal the vent hole in a state that the extinguishing gas has been injected into the chamber.

### CROSS-REFERENCE TO RELATED APPLICATION

This application claims the benefit of Korean Patent Application No. 10-2010-0100774, filed on Oct. 15, 2010, which is hereby incorporated by reference for all purposes as if fully set forth herein.

### BACKGROUND OF THE INVENTION

1. Field of the Invention

The present invention relates to an electromagnetic switch, and particularly, to an electromagnetic switch capable of injecting extinguishing gas into a hermetic space thereof and sealing the hermetic space.

2. Background of the Invention

In an electric vehicle such as a hybrid vehicle, a fuel cell vehicle, a golf cart and a motor forklift, an electromagnetic switch is installed between an accumulator and a direct current (DC) converter to supply DC power from the accumulator to the DC converter, or to interrupt DC power supply to the DC converter from the accumulator.

In an eco-friendly generation system such as a solar power generation system and a wind power generation system, the electromagnetic switch is installed between a DC generator and an inverter for converting DC power into alternating current (AC) power having a commercial frequency and a voltage, and thus to supply DC power from the DC generator to the inverter, or to interrupt DC power supply to the inverter from the DC generator.

In the electromagnetic switch used in an electric vehicle, the occurrence of arcs has to be minimized, and the occurrence of noise has to be minimized for a quiet indoor atmosphere.

The electromagnetic switch is provide with a fixed contact and a movable contact, and may comprise an actuator configured to drive the movable contact so as to control open and close of the movable contact.

Especially, in the electromagnetic switch used in an electric vehicle, when the movable contact is instantaneously separated from the fixed contact (when the movable contact is switched off), arcs may occur. In order to rapidly extinguish the arcs, a space where the contacts are disposed has to be sealed. Furthermore, the hermetic space has to be filled with extinguishing gas.

In order to maintain the lifespan of electric components and to enhance the reliability, a sufficient amount of extinguishing gas has to be filled in the hermetic space. This may require techniques to implement a sealing structure for extinguishing gas.

### SUMMARY OF THE INVENTION

Therefore, an aspect of the detailed description is to provide a method for manufacturing an electromagnetic switch capable of sealing a space configured to contain therein extinguishing gas for extinguishing arcs generated when a contact of the electromagnetic switch is switched off.

Another aspect of the detailed description is to provide a method for sealing a hermetic space of an electromagnetic switch with using no additional materials.

To achieve these and other advantages and in accordance with the purpose of this specification, as embodied and broadly described herein, there is provided an apparatus for manufacturing an electromagnetic switch, the apparatus comprising: a chamber having an inner space hermetically sealed from outside; an extinguishing gas injector configured to inject extinguishing gas into the chamber; a supporter disposed in the chamber, and configured to support a temporary assembly having a vent hole at one side thereof; and a sealing means configured to seal the vent hole in a state that the extinguishing gas has been injected into the chamber.

A component configured to form a sealing space for sealing extinguishing gas may be disposed in the chamber having an atmosphere of the extinguishing gas, and the vent hole may be blocked in the chamber such that the extinguishing gas is easily sealed in the electromagnetic switch.

The sealing means may include a member supporter configured to contact a blocking member to the vent hole, and a welding means configured to weld the member supporter to a peripheral portion of the vent hole.

To achieve these and other advantages and in accordance with the purpose of this specification, as embodied and broadly described herein, there is also provided a method for manufacturing an electromagnetic switch, the method comprising: manufacturing a housing having an upper side where a fixed contact is disposed, and having another open side; manufacturing a plate having a movable contact movably mounted to a central part thereof; forming a vent hole at the plate; sealing an inner space of the housing by bonding the plate to an open end of the housing; forming an atmosphere of extinguishing gas in the chamber in a state that the housing and a temporary assembly of the plate are disposed in the chamber; and blocking the vent hole.

The housing and the plate may serve as members for forming a sealing space where the extinguishing gas is sealed. However, the present invention may not be limited to this. That is, the housing and the plate may be replaced by any component which forms the sealing space where the extinguishing gas is sealed.

The step of manufacturing a plate may include coupling a cylinder having a core mounted therein to the plate, the core for driving the movable contact.

The step of sealing the vent hole may include contacting a blocking member for blocking the vent hole to the vent hole; and bonding the blocking member to a peripheral portion of the vent hole by welding in a state that the blocking member has contacted the peripheral portion of the vent hole.

The blocking member and the peripheral portion of the vent hole may be bonded to each other by resistant-welding or projection-welding.

The step of bonding the housing and the plate to each other may include fixing a connector formed of a metallic material into the housing, and bonding the plate to a lower part of the connector.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a sectional view illustrating an electromagnetic switch manufactured by a manufacturing apparatus according to the present invention;

FIG. 2 is a sectional view illustrating a contacted state between a fixed contact and a movable contact of the electromagnetic switch illustrated in FIG. 1;

FIG. 3 is a sectional view illustrating a hermetic space of the electromagnetic switch illustrated in FIG. 1, into the hermetic space extinguishing gas is injected; and

FIG. 4 is a sectional view schematically illustrating an inner structure of an apparatus for manufacturing an electromagnetic switch according to one embodiment of the present invention.

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

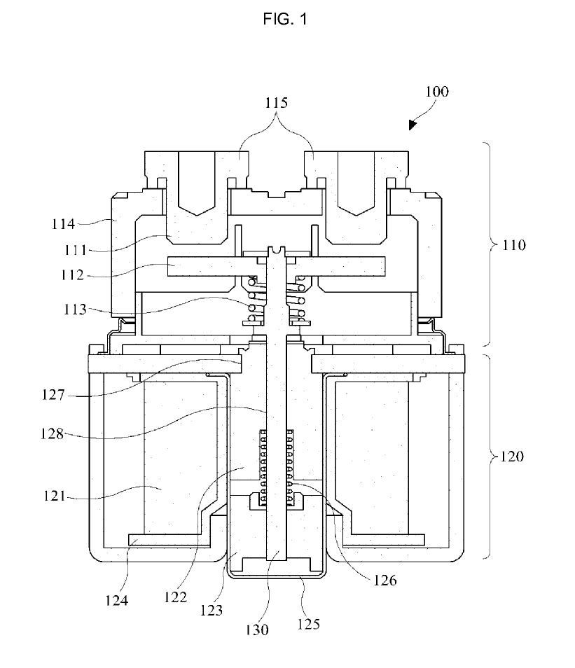

FIG. 1 is a sectional view illustrating an electromagnetic switch manufactured by a manufacturing apparatus according to one embodiment of the present invention. Referring to FIG. 1, the electromagnetic switch 100 comprises an extinguishing unit 110 and a driving unit 120.

The extinguishing unit 110 is provided with a fixed contact 111 and a movable contact 112, and includes a structure to open and close the movable contact so that an external device connected to the electromagnetic switch 100 is switched on/off.

The driving unit 120 includes an actuator configured to control open and close of the contact by using an electric signal. Generally, the electromagnetic switch 100 is configured to switch on/off an external device connected thereto by up-down moving the driving unit 120 through the actuator.

The driving unit 120 may consist of an exciting coil 121 configured to generate a driving force of the movable contact by generating a magnetic force due to an electric signal, a fixed core 122 fixed in the exciting coil 121, and a movable core 123 disposed to face the fixed core 122.

A coil bobbin 124 on which the exciting coil 121 is wound is provided between the exciting coil 121 and the fixed and movable cores 122, 123. The fixed core 122 and the movable core 123 are arranged in upper and dower directions along an axial direction of the coil bobbin 124. The fixed core 122 and the movable core 123 form a magnetic path through which a magnetic flux density generated by the exciting coil 121 passes. By the magnetic flux density generated by the exciting coil 121, the movable core 123 has a driving force to move in upper and lower directions.

Between the coil bobbin 124 and the fixed and movable cores 122,123, disposed is a plunger cap or a cylinder 125 formed of a non-magnetic material and formed in a cylindrical shape having an open surface at the side of the extinguishing unit and having a closed bottom surface at the opposite side.

The plunger cap or the cylinder 125 is formed in a shape of a vessel to accommodate the fixed core 122 and the movable core 123 therein. Each of the fixed core 122 and the movable core 123 is formed to have an outer diameter approximately equal to an inner diameter of the plunger cap 125, thereby implementing a cylindrical shape. The movable core 123 is moveable to an axial direction of the plunger cap 125.

A moving range of the movable core 123 is determined between a contact position to the fixed core 122, and an initial position separated from the bottom surface of the plunger cap 125. A contact force to contact the movable core 123 to the fixed core 122 is provided by a coil spring by the exciting coil 121, and a spring force in a direction that the movable core 123 returns to the initial position is provided by a return spring 126.

A through hole 127 for fitting the fixed core 122 thereinto is installed at a central part of the driving unit 120, and the fixed core 122 is fixed to the driving unit 120 in a fitted manner to the through hole 127.

The movable core 123 approaching to or spacing from the fixed core 122 is provided at a central part of the driving unit 120. A guide configured to guide a motion of the movable core 123 may be provided at an inner side of the coil bobbin 124 of the driving unit 120.

At a central part of the fixed core 122 and the movable core 123, provided is a through hole 128 through which a shaft 130 is penetratingly installed. The shaft 130 connects the extinguishing unit 110 and the driving unit 120 to each other by penetrating therethrough. The movable contact 112 is coupled to an upper end of the shaft 130, and the movable core 123 is coupled to a lower end of the shaft 130. Under this configuration, an up-down motion of the movable core 123 is transmitted to the movable contact 112.

The housing 114 formed in a box shape with a lower open side is disposed on the driving unit 120. Terminal holes are formed at an upper part of the housing 114, through which the fixed contact 111 and the fixed terminal 115 are inserted into the housing 114.

The movable contact 112 movable to contact or to be separated from the fixed contact 111 is disposed in the housing 114. The movable contact 112 is coupled to the shaft 130 below the fixed contact 111.

Below the movable contact 112, provided is a push spring 113 configured to provide an elastic force when the movable contact 112 contacts the fixed contact 111. By the push spring 113, the movable contact 112 and the fixed contact 111 may maintain a contacted state therebetween with a pressure more than a predetermined value. Furthermore, the push spring 113 may reduce a moving speed of the movable core 123 and the shaft 130 when the movable contact 112 is separated from the fixed contact 111, thereby attenuating an impact force occurring when the movable core 123 comes in contact with the plunger cap 125. This may restrict the occurrence of noise and vibrations.

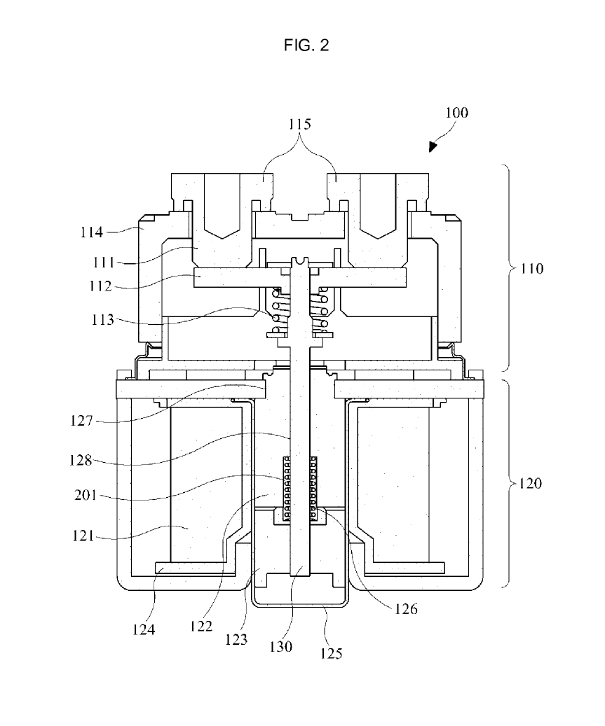

FIG. 2 is a sectional view illustrating a contacted state between the fixed contact and the movable contact of the electromagnetic switch illustrated in FIG. 1. As aforementioned, once a current is applied to the exciting coil 121, a magnetic flux is generated at the periphery of the exciting coil 121. By this magnetic flux, the fixed core 122 and the movable core 123 have different polarities. As the movable core 123 is attracted to the fixed core 122, the movable core 123 and the fixed core 122 come in contact with each other. When the movable core 123 is disposed at a contact position to the fixed core 122, the fixed contact 111 and the movable contact 112 come in contact with each other. Once the fixed contact 111 and the movable contact 112 come in contact with each other, power is supplied to an external device, which is shown in FIG. 2.

When current supply to the exciting coil 121 is interrupted, a magnetic force is not generated from the exciting coil 121 any longer, and the movable core 123 loses its driving force. As a result, the movable core 123 returns to the initial position by an elastic force of the return spring 126. At the same time, the shaft 130 moves, and the movable contact 112 is separated from the fixed contact 111.

Here, the return spring 126 is accommodated in a spring accommodation recess 201 of the fixed core 122. When the movable core 123 moves to a contact position (FIG. 2) to the fixed core 122, the return spring 126 does not interfere with the contact between the movable core 123 and the fixed core 122. The reason is because the entire part of the return spring 126 has been accommodated in the spring accommodation recess 201 in a compressed state. Once the movable core 123 returns to the initial position, power supply to the external device is stopped, which is shown in FIG. 1.

The electromagnetic switch serves to switch an external device by repeatedly being in the closed state shown in FIG. 2 and the open state shown in FIG. 1.

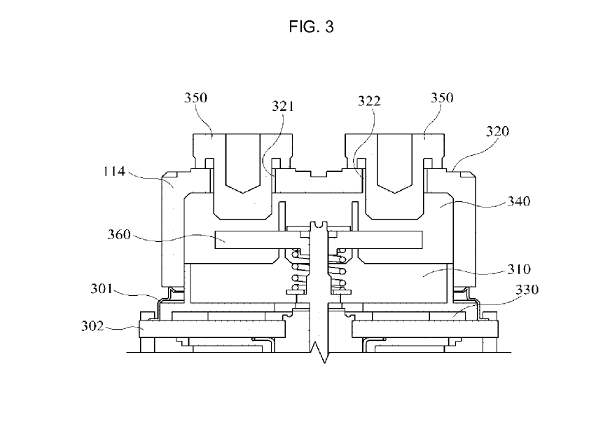

FIG. 3 is a sectional view illustrating a hermetic space of the electromagnetic switch illustrated in FIG. 1, into the hermetic space extinguishing gas is injected.

Referring to FIG. 3, in order for the fixed core 122 and the movable core 123 to be accommodated in a hermetic space, the housing 114, a connector 301, an upper plate 302 and the plunger cap 125 are installed, and then are bonded to one another. As a result, formed is a hermetic space encompassed by the housing 114, the connector 301 and the plunger cap 125. Accordingly, the extinguishing unit 110, the fixed core 122 and the movable core 123 may be accommodated in the hermetic space. The housing 114 is formed in a box shape, and is formed of a heat-resistant material such as ceramic. The housing 114 is provided with an opening 310 at a lower part thereof, and is provided with two terminal holes 321 and 322 at an upper part 320 thereof. The connector 301 is formed of a metallic material, etc., and is bonded to the opening 310 of the housing 114 thus to have an opening 330 at a lower part thereof. The opening 330 of the connector 301 is bonded to the upper plate 302 by a bonding method such as welding.

As the connector 301 and the upper plate 302 are bonded to each other, the housing 114 forms a hermetic space 340 for accommodating therein the fixed contact 111 and the movable contact 112. Insulation gas having hydrogen as a main component is filled in the hermetic space 340.

Each fixed terminal 350 within the hermetic space 340 is formed in a cylindrical shape, and is implemented as an electric conductor formed of copper, etc. The fixed terminal 350 is provided with a fixed contact at a lower end thereof, and is provided with a shielding portion at an upper end thereof. An external device is connected to the shielding portion. A movable contactor 360 is formed on a plate as an electric connector formed of copper, etc., and is provided with the movable contact on an upper surface thereof. The movable contact is integrally formed with the movable contactor 360.

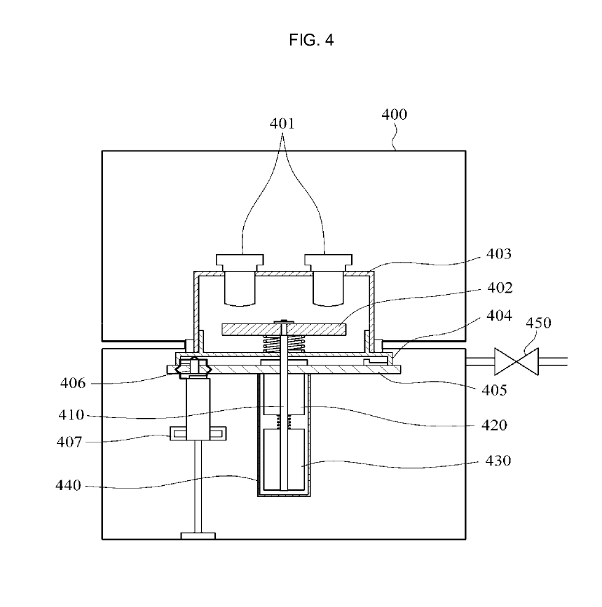

FIG. 4 is a sectional view schematically illustrating an inner structure of an apparatus for manufacturing an electromagnetic switch according to one embodiment of the present invention.

Referring to FIG. 4, a fixed contact 401 and a movable contact 402 are disposed in a hermetic space implemented by bonding a housing 403 formed of ceramic, etc., a connector 404 and a plate 405 to one another.

The movable contact 402 is connected to a shaft 410, and the shaft 410 is coupled to the movable core 430 by sequentially penetrating through the connector 404, the plate 405, and a fixed core 420 fixed to a lower part of the plate 405.

A cylinder 440 is fixedly-coupled to the plate 405, and accommodates therein the fixed core 420 fixed to a lower part of the plate 405 and the movable core 430.

As the housing 403, the connector 404, the plate 405 and the cylinder 440 are coupled to one another, a sealing structure (assembly) is implemented.

The sealing structure is inserted into a chamber 400 in a state that a vent hole 406 has been formed at a part of the plate 405.

In this state, insulation gas is injected into the chamber 400 by using a gas pump 450. As the insulation gas, hydrogen (H₂) is mainly used. Alternatively, a mixture gas of hydrogen (H₂) and nitrogen (N₂), etc. may be used. The insulation gas may be injected into the sealing structure with a pressure more than a predetermined pressure (atmospheric pressure of about 2026 mb) for facilitation. Before the insulation gas is injected into the chamber 400, a vacuum state may be implemented in the chamber 400. In case of using a mixed gas, the mixed gas may be injected into the chamber 400, or each gas of the mixed gas may be sequentially injected into the chamber 400.

Once an atmosphere of an insulation gas is formed in the chamber 400, insulation gas is supplied into the chamber 400 through the vent hole 406 of the plate 405. As a result, the insulation gas is injected into the assembly.

After time has lapsed enough for the insulation gas to be injected into the assembly, the vent hole 406 of the plate 405 is bonded to seal the assembly. In case of sealing the assembly, a blocking member for blocking the vent hole 406 is made to contact the vent hole 406. Then, the blocking member contacting the vent hole 406 is bonded to a peripheral portion of the vent hole by projection-welding, etc.

Then, the insulation gas is filled in the hermetic space, and a driving unit having an actuator is coupled to the sealed assembly. Accordingly, the electromagnetic switch is completed. This completed electromagnetic switch may be used as a direct current (DC) converter for supplying DC power or interrupting DC power supply.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An apparatus for manufacturing an electromagnetic switch, the apparatus comprising:
a chamber having an inner space hermetically sealed from outside;
an extinguishing gas injector configured to inject extinguishing gas into the chamber;
a supporter disposed in the chamber, and configured to support a temporary assembly having a vent hole at one side thereof; and
a sealing means configured to seal the vent hole in a state that the extinguishing gas has been injected into the chamber.

2. The apparatus of claim 1, wherein the sealing means comprises:
a member supporter configured to contact a blocking member to the vent hole; and
a welding means configured to weld the member supporter to a peripheral portion of the vent hole.

3. A method for manufacturing an electromagnetic switch, the method comprising:
manufacturing a housing having an upper side where a fixed contact is disposed, and having another open side;
manufacturing a plate having a movable contact movably mounted to a central part thereof;
forming a vent hole at the plate;
sealing an inner space of the housing by bonding the plate to an open end of the housing;
forming an atmosphere of extinguishing gas in the chamber in a state that the housing and a temporary assembly of the plate are disposed in the chamber; and
blocking the vent hole.

4. The method of claim 3, wherein the step of manufacturing a plate comprises coupling a cylinder having a core mounted therein to the plate, the core for driving the movable contact.

5. The method of claim 3, wherein the step of sealing the vent hole comprises:
contacting a blocking member for blocking the vent hole onto the vent hole; and
bonding the blocking member to a peripheral portion of the vent hole by welding in a state that the blocking member has contacted the peripheral portion of the vent hole.

6. The method of claim 5, wherein the blocking member and the peripheral portion of the vent hole are bonded to each other by resistant-welding or projection-welding.

7. The method of claim 3, wherein the step of bonding the housing and the plate to each other comprises:
fixing a connector formed of a metallic material into the housing; and
bonding the plate to a lower part of the connector.
